(19) United States
(12) Patent Application Publication
(10) Pub. No.: US 2002/0109711 A1
(43) Pub. Date: Aug. 15, 2002

(54) Method for automatic controlling the display of the object on the display panel

(75) Inventors: Tong S. Chen, Taipei (TW); Kuang-Shin Lin, Taipei (TW)

Correspondence Address: BAKER & BOTTS, 30 ROCKEFELLER PLAZA, NEW YORK, NY, 10112

(73) Assignee: INVENTEC CORPORATION

(21) Appl. No.: 09/783,764

(22) Filed: Feb. 15, 2001

(51) Int. Cl. G09G 5/00

(52) U.S. Cl. 345/727

(57) ABSTRACT

A method for automatic controlling the display of the object on the display panel comprises two steps, establishing a pattern and regulating an object on the display panel. The first step is to establish the pattern, which is based on the need of expected protocol for users or soft/hardware constituent, so that the items on the display panel of control program can be made out. The second step is to control the display of the object on the display panel, which automatically finds whether the relative items are on the display panel of the control program. If no items exist in it, the volume regulating on the display panel is controlled using the establishing pattern in the first step.

### FIELD OF THE INVENTION

The present invention relates to a method for automatic controlling the display of the object on the display panel. More particularly, the present invention relates to an automatic controlling the volume regulating on the display panel. The invention applies to all hardware devices and computers having windows environment, and ensures all computers having the same object on the display panel when exported. For example, the same volume regulating on the display panel.

### BACKGROUND OF THE INVENTION

Some software and desktops in computers, for example Micro-soft Windows software, have many kinds of default control options which are the standard format for exported computers. However, the controlling options are usually to be set as the default status by operator or tester.

However, before controlling the object of the computer volume (volume control, right/left channel, or silence), we should first show the items of the relate object in the volume control program, and then we can control them (increase or delete some items). Actually, the volume regulating on the display panel is controlled by user or hard/software operators who decide which items are showed on the display panel or not, then show the items on the display panel by using their hand. Therefore, the efficiency is bad, and it is very easy to make some mistakes of item loss or showing the wrong items by operators' errors, so that the volume regulating on the display panel is not the same between computers. For soft/hardware firms, the product damages will cause the user's unsatisfied at quality and reputation of them. Therefore, they need a method for automatic controlling the display of the object on the display panel.

### SUMMARY OF THE INVENTION

It is therefore an objective of this invention to provide a method for automatic controlling the volume regulating on the display panel. So that, the method can efficiently solve the shortcoming generated by the prior art method for controlling the volume regulating on the display panel.

It is another objective of this invention to provide a method for automatic controlling the volume regulating on the display panel. So that, it avoids the complex steps in setting up or operators' errors.

It is another objective of this invention to provide a method for automatic controlling the volume regulating on the display panel. So that, during the setting up process, it increases the accuracy and efficiency.

It is another objective of this invention to provide a method for automatic controlling the volume regulating of the objecton the display panel. This method is extensively suitable for computer hardware, and is not limited by any computer types or hardware devices.

In accordance with the foregoing and other objects of this invention, this invention provides a method for automatic controlling the display of the object on the display panel. The invention includes the following steps, establishing a pattern, and then controlling an object on the display panel.

In accordance with the foregoing and other objects of this invention, this invention provides a method for establishing a pattern including the following steps:

Opening a control program, controlling an object on the display panel, closing the control program, Reading a data, and establishing a pattern by writing the data into the pattern.

In accordance with the foregoing and other objects of this invention, this invention provides a method for automatic controlling the display of the object on the display panel. The invention includes the following steps:

Establishing a pattern, which has a data, opening a control program, Testing if a item is in the object on the display panel of the control program, closing the control program, and if find the item, another data is covered by the data of the pattern.

### BRIEF DESCRIPTION OF THE DRAWINGS

The invention will be more fully understood from the detailed description given herein below and the accompanying drawing, which are given by way of illustration only, and thus do not limit the present invention, and wherein:

FIG. 1 is a flow chart showing the steps of this invention for automatic controlling the volume regulating on the display panel.

FIG. 2 is a flow chart showing this invention of establishing the pattern; and

FIG. 3 is a flow chart showing this invention for automatic controlling the display of the object on the display panel.

### DETAILED DESCRIPTION OF THE PREFERRED EMBODIMENT

The method for automatic controlling the display of the object on the display panel in this invention comprises two steps, which are establishing a pattern and controlling an object on the display panel. The first step is to establish the pattern, which is based on the need of expected protocol for users or soft/hardware constituent, so that the items on the display panel in control program can be made out. The second step is to control the object on the display panel, which automatically finds whether the relative items are on the display panel of control program. If the item existed, the first step of controlling the object on the display panel need not be executed. Furthermore, the method for automatic controlling the display of the object on the display panel in this invention is not limited in automatic controlling the volume regulating on the display panel. This invention also can make use of controlling other objects on the display panel.

The detail embodiment and method for solving the convention is described as follow:

If the users or operators need an automatic test option in computer volume regulating option, like the volume control in MIDI, right/left channel control, or silence, it is solved by using the described method of this invention. Furthermore, the application method for automatic controlling the display of the object on the display panel in this invention is not only limited in solving the three options above, but also solved any volume regulating options.

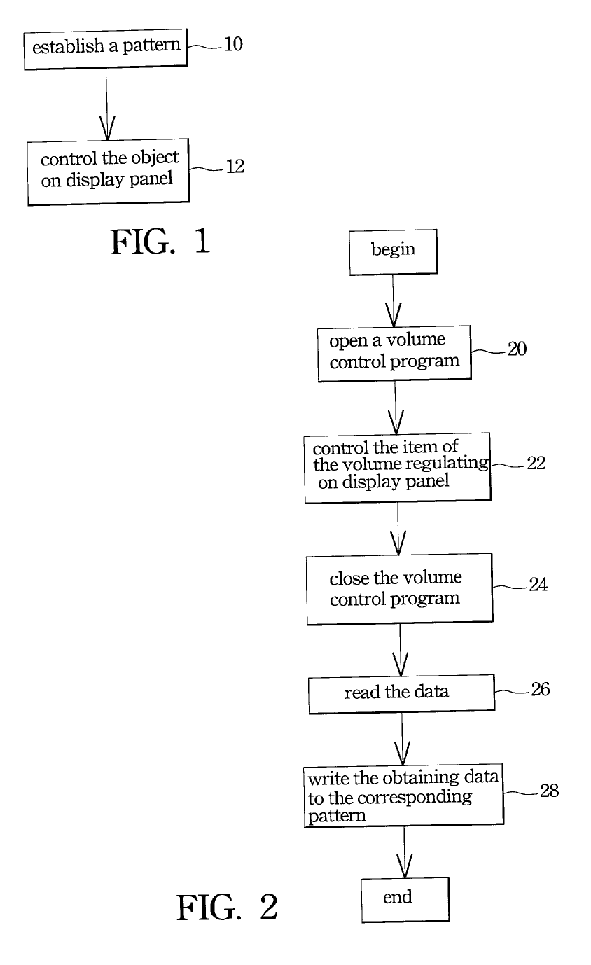

Referring to FIG. 1, a flow chart of the steps in this invention for automatic controlling the volume regulating on the display panel is showed. This invention comprises two steps, which are establishing a pattern and controlling the volume regulating on the display panel. First, establish a pattern 10. Then, test whether volume control options are exist in the volume regulating on the display panel of the control program. If they do not exist, then do the next step 12, which is to control the object on the display panel from the pattern established by step 10. If volume control options exist in the pattern, then the step 12 need not be executed.

FIG. 2 is the detailed flow chart of establishing the document in step 10. Referring to FIG. 2, which is a flow chart showing this invention of establishing the pattern. First, open a volume control program 20, then control the items of volume regulating on the display panel 22 in volume control program, which is based on the need of expected protocol or users. That is, testers or operators can follow this protocol to control the display panel. For example, if it is needed for the exported protocol to display the volume regulating on the display panel having the items of MIDI and right/left channel, the items of MIDI and right/left channel options can be showed on the control panel.

Then, performs the step 24, which is to close the volume control program. After that, performs the step 26, which is to read the data. From the database, we can read the data of items. For example, we find the folder of the sound card from the path of register bank, HKEY_CURRENT_USER\Software\Microsoft\Windows\Current Verson\Applets\Volume Control, and then read the data from the folder, such as the filename, LineState, from the three subfolders of volume control, record control, and voice. The path above is an example in windows system. This invention not only applies in this field, but also applies in other software or desktops, like the desktop of Macintosh whose item data can be read in the corresponding path of register bank. Furthermore, the sound card is installed in the computer, such as voice card, or sound braster card. This invention does not limit in any sound card, so that every sound card is suitable for this invention. Furthermore, the embodiment above use LineStates as the filename, but any filename are suitable if the files have the same function like LineStates. It does not limit our invention.

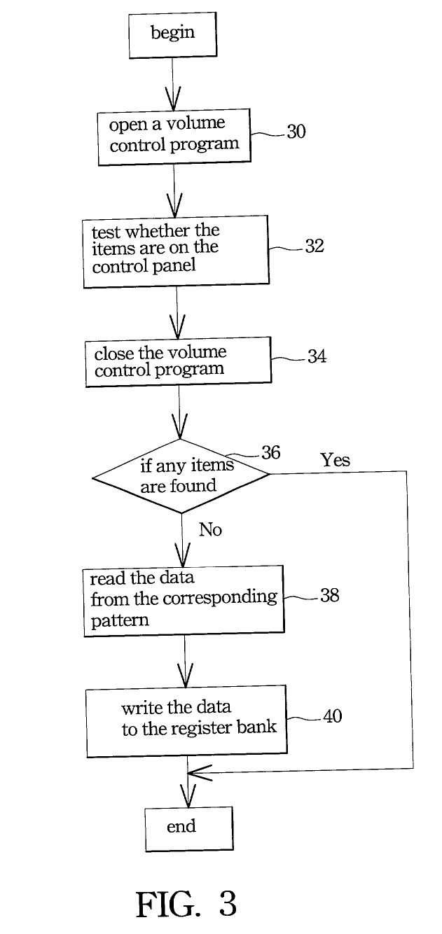

The next step 28 is to write the obtaining data to the corresponding pattern. For example, the obtaining data is written to the corresponding pattern of volume control (VolCtrol.dat), record control (Rec.dat) and voice (Other.dat). Hence, the establishing pattern of step 10 is finished. The automatically regulating the object on the display panel of step 12 in FIG. 1 is showed in FIG. 3, and is described as follow:

Referring to FIG. 3, a flow chart for automatic controlling the display of the object on the display panel is showed. That is, the flow chart can automatic control the display object on the display panel., so that the exported computers have a standard object on the display panel.

The first step 30 is to open the volume control program of the computers, which expect to test.

The next step 32 is to test whether the items, which the user need or export need are on the control panel of volume control panel. Then, close the volume control program 34.

The next step 36 is to determine if any items found in step 32 are showing on the display panel. If no items are found, then read the data 38 from the corresponding pattern established in the steps of FIG. 2.

The next step 40 is to write the data. The data, which is obtained in step 38 is written or covered to the path of register bank, HKEY_CURRENT_USER\Software\Microsoft\Windows\Current Verson\Applets\Volume Control\ corresponding LineState in the sound card. Similarly, the path above is an example in windows system. This invention not only applies in this field, but also applies in other software or desktops, like the desktop of Macintosh whose item data can be read in the corresponding path of register bank. Furthermore, the sound card is installed in the computer, such as voice card, or sound braster card. This invention does not limit any sound card, so that every sound card is suitable for this invention. Furthermore, the embodiment above use LineStates as the filename, but any filename are suitable if the files have the same function like LineStates. It does not limit our invention, too.

If expected items are found in the step 36, then reading the data in step 38 and write the data in step 40 can be skipped. Hence, this invention of a method for automatic controlling the volume regulating on the display panel is disclosed.

To sum up, this invention provides a method for automatic controlling the volume regulating on the display panel. So that, the method can efficiently solve the shortcoming generated by the prior art method for controlling the volume regulating on display pane.

This invention provides a method for automatic controlling the volume regulating on the display panel. So that, it avoids the complex steps in setting up or operators' errors.

This invention provides a method for automatic controlling the volume regulating on the display panel. So that, during setting up process, they increase the accuracy and efficiency

This invention provides a method for automatic controlling the volume regulating on the display panel. This method is extensively suitable for use in computer hardware, and is not limited by any computer types or hardware devices.

While the preferred embodiment of the invention has been illustrated and described, it will be appreciated that various changes can be made therein without departing from the spirit and scope of the invention.

What is claimed is:

1. A method for automatic controlling a volume regulating on a display panel, comprising the steps of:
establishing a pattern; and
regulating an object on the display panel.

2. The method of claim 1, wherein the step of regulating the object on the display panel includes:
controlling the object on the display panel;
reading a data; and
writing the data to the pattern, and the pattern is established.

3. The method of claim 2, wherein before writing the data step comprises closing the object on the display panel.

4. The method of claim 2, wherein the data is stored in a register bank.

5. The method of claim 1, wherein the object on the display panel is a volume regulating control on the display panel.

6. The method of claim 1, wherein the step of controlling the object on the display panel comprises using the pattern.

7. The method of claim 6, wherein controlling the object on the display panel comprises the step of:
reading the data of the pattern; and
covering the data in a register bank.

8. The method of claim 7, wherein a filename of the data is LineStates.

9. A method for establishing a pattern, comprising:
opening a control program;
controlling an object on a display panel;
closing the control program;
reading a data; and
writing the data to the pattern, and the pattern is established.

10. The method of claim 9, wherein the control program is a volume control program.

11. The method of claim 9, wherein the object on the display panel is a volume regulating control on the display panel.

12. The method of claim 9, wherein a filename of the data is LineStates.

13. The method of claim 9, wherein the data is stored in a register bank.

14. A method for automatic controlling a volume regulating on a display panel, comprising the steps of:
establishing a pattern;
opening a control program;
whether the expected items are on the display panel of the control program;
closing the control program; and
If no items are found, another data is covered by a data of the pattern.

15. The method of claim 14, wherein the object on the display panel is a volume regulating control on the display panel.

16. The method of claim 14, wherein a filename of the data is LineStates.

17. The method of claim 14, if the items are found, the data in the pattern need not cover another data.

18. The method of claim 14, wherein the data is stored in a register bank.
